(19) United States
(12) Patent Application Publication
(10) Pub. No.: US 2026/0330599 A1
(43) Pub. Date: Oct. 22, 2026

(54) INFORMATION PROCESSING APPARATUS, INFORMATION PROCESSING METHOD AND PROGRAM

(71) Applicant: INSTITUTE OF SCIENCE TOKYO, Tokyo (JP)

(72) Inventors: Ryo Onishi, Tokyo (JP); Yuki Yasuda, Tokyo (JP)

(73) Assignee: INSTITUTE OF SCIENCE TOKYO, Tokyo (JP)

(21) Appl. No.: 19/113,231

(22) PCT Filed: Sep. 29, 2023
(86) PCT No.: PCT/JP2023/035615

§ 371 Date: Mar. 19, 2025

(30) Foreign Application Priority Data
Sep. 29, 2022 (JP) 2022-155991

(51) Int. Cl. G06T 3/4053; G06V 20/10

(52) U.S. Cl. CPC G06T 3/4053; G06V 20/182

(57) ABSTRACT

An information processing apparatus that can perform prediction of a state of an environment with high accuracy and efficiently is provided. A structure transforming unit (30) transforms a structure of observation data obtained by observing a state in space-time into observation data having a structure of grid data. A latent space-time mapping unit (40) maps the observation data transformed into the grid data and prediction data from first real space-time to latent space-time. A non-linear transformation unit (50) performs non-linear transformation in the latent space-time on the observation data and the prediction data having been mapped. A high-resolution analytical data acquisition unit (60) maps the observation data and the prediction data subjected to the non-linear transformation from the latent space-time to second real space-time, to acquire high-resolution analytical data.

### TECHNICAL FIELD

The present disclosure relates to an information processing apparatus, an information processing method, and a program.

### BACKGROUND ART

In the field of meteorological prediction, oceanographic phenomena prediction, or the like, for example, it is requested to predict a state of an environment with high accuracy and efficiently by simulation or the like. Similarly, it is also requested to efficiently predict a state of an environment in an apparatus. Approaches for improving the accuracy of prediction include resolution increase (super-resolution) and data assimilation. In connection with this technology, Non Patent Literature 1 discloses a technology of super-resolution data assimilation (SRDA). In addition, Non Patent Literature 2 to Non Patent Literature 5 disclose technologies related to the present disclosure.

### CITATION LIST

### Non Patent Literature

### Non Patent Literature 1

Sebastien Barthelemy, et al, “Super-resolution data assimilation”, Ocean Dynamics 72, 661-678 (2022), https://doi.org/10.1007/s10236-022-01523-x

### Non Patent Literature 2

Bin Li, et al, “3D-ReConstnet: A Single-View 3D-Object Point Cloud Reconstruction Network”, IEEE Access, 2020, https://ieeexplore.ieee.org/documedo/9086481?source=authoralert

### Non Patent Literature 3

Ashish Vaswani, et al, “Attention is all you need”, Advances in neural information processing systems, 2017, https://arxiv.org/abs/1706.03762

### Non Patent Literature 4

Zhicheng Geng, et al, “RSTT: Real-time Spatial Temporal Transformer for Space-Time Video Super-Resolution”, Computer Vision and Pattern Recognition, 27 Mar. 2022, https://arxiv.org/abs/2203.14186

### Non Patent Literature 5

Wenzhe Shi, et al, “Real-Time Single Image and Video Super-Resolution Using an Efficient Sub-Pixel Convolutional Neural Network”, Computer Vision and Pattern Recognition, 2016, https://arxiv.org/abs/1609.05158

### SUMMARY OF INVENTION

### Technical Problem

The technology according to Non Patent Literature 1 only simply combines a super-resolution approach and a data assimilation approach. Thus, Non Patent Literature 1 performs data assimilation by ensemble computation. Herein, the ensemble computation requires various similar situations to be simulated. Therefore, an attempt to perform prediction with high accuracy with the technology according to Non Patent Literature 1 might result in increased computational cost. Hence, the technology according to Non Patent Literature 1 might fail to perform prediction with high accuracy and efficiently.

The present disclosure has an object to provide an information processing apparatus, an information processing method, and a program that can predict a state of an environment with high accuracy and efficiently.

### Solution to Problem

An information processing apparatus according to the present disclosure includes a structure transforming unit configured to transform a structure of observation data which is data obtained by observing a state in space-time into observation data having a structure of grid data indicating numerical values defined on grid points arranged at a predetermined interval in the space-time, a latent space-time mapping unit configured to map the observation data transformed into the grid data and prediction data in a time period at least including a time point of the observation data and a past with respect to the time point, which is grid data in the space-time obtained by simulation, from first real space-time to latent space-time having a smaller number of elements than that in the first real space-time, a non-linear transformation unit configured to perform non-linear transformation in the latent space-time on the observation data and the prediction data having been mapped, and a high-resolution analytical data acquisition unit configured to map the observation data and the prediction data subjected to the non-linear transformation from the latent space-time to second real space-time having a larger number of elements than that in the latent space-time and having higher resolution than that in the first real space-time, to acquire high-resolution analytical data which is grid data in the space-time and which has higher resolution in the space-time than that in the prediction data, in which data assimilation of the observation data and the prediction data is performed by the latent space-time mapping unit and the non-linear transformation unit.

An information processing method according to the present disclosure includes transforming a structure of observation data which is data obtained by observing a state in space-time into observation data having a structure of grid data indicating numerical values defined on grid points arranged at a predetermined interval in the space-time, mapping the observation data transformed into the grid data and prediction data in a time period at least including a time point of the observation data and a past with respect to the time point, which is grid data in the space-time obtained by simulation, from first real space-time to latent space-time having a smaller number of elements than that in the first real space-time, performing non-linear transformation in the latent space-time on the observation data and the prediction data having been mapped, and mapping the observation data and the prediction data subjected to the non-linear transformation from the latent space-time to second real space-time having a larger number of elements than that in the latent space-time and having higher resolution than that in the first real space-time, to acquire high-resolution analytical data which is grid data in the space-time and which has higher resolution in the space-time than that in the prediction data, in which data assimilation of the observation data and the prediction data is performed by the mapping from the first real space-time to the latent space-time and the performing the non-linear transformation in the latent space-time on the observation data and the prediction data.

A program according to the present disclosure causes a computer to execute processing of transforming a structure of observation data which is data obtained by observing a state in space-time into observation data having a structure of grid data indicating numerical values defined on grid points arranged at a predetermined interval in the space-time, processing of mapping the observation data transformed into the grid data and prediction data in a time period at least including a time point of the observation data and a past with respect to the time point, which is grid data in the space-time obtained by simulation, from first real space-time to latent space-time having a smaller number of elements than that in the first real space-time, processing of performing non-linear transformation in the latent space-time on the observation data and the prediction data having been mapped, and processing of mapping the observation data and the prediction data subjected to the non-linear transformation from the latent space-time to second real space-time having a larger number of elements than that in the latent space-time and having higher resolution than that in the first real space-time, to acquire high-resolution analytical data which is grid data in the space-time and which has higher resolution in the space-time than that in the prediction data, in which data assimilation of the observation data and the prediction data is performed by the processing of mapping from the first real space-time to the latent space-time and the processing of performing the non-linear transformation in the latent space-time on the observation data and the prediction data.

### Advantageous Effects of Invention

According to the present disclosure, an information processing apparatus, an information processing method, and a program that can predict a state of an environment with high accuracy and efficiently can be provided.

### BRIEF DESCRIPTION OF DRAWINGS

FIG. 1 is a diagram for describing computational resolution and grid data;

FIG. 2 is a diagram for describing the computational resolution and the grid data;

FIG. 3 is a diagram for describing a super-resolution simulation method;

FIG. 4 is a diagram showing a configuration of an information processing apparatus according to the present embodiment;

FIG. 5 is a flowchart showing an information processing method to be executed by the information processing apparatus according to the present embodiment;

FIG. 6 is a diagram showing a configuration of an information processing apparatus according to a first embodiment;

FIG. 7 is a diagram for describing a technology according to a comparative example;

FIG. 8 is a diagram for describing super-resolution and data assimilation according to the first embodiment;

FIG. 9 is a comparative diagram of an experimental result according to the first embodiment and an experimental result according to the comparative example;

FIG. 10 is a diagram for describing a method for training constituent elements according to the first embodiment by a variational Bayesian method; and

FIG. 11 is a block diagram schematically showing a hardware configuration example of a computing processing apparatus that can implement an apparatus and a system according to each embodiment.

### DESCRIPTION OF EMBODIMENTS

### Overview of Embodiment

Prior to description of an embodiment, an overview of the present embodiment will be described. Note that although the present embodiment will be described below, the following embodiment does not limit an invention according to the appended claims. In addition, all of combinations of features described in the embodiment are not necessarily essential for means for solving the problems of the invention. In addition, indices (such as alphabetical characters) used in the following description are not necessarily common throughout the present specification.

In the field of meteorological prediction (meteorological predictive simulation), for example, micrometeorological prediction is applied in some cases. Micrometeorology refers to meteorology for the neighborhood of the ground up to an altitude of approximately 100 m, which is greatly affected by artificial structures and human activities. Micrometeorological prediction provides a high-resolution simulation result approximately 100 to 1000 times higher than that in general meteorological prediction. Micrometeorological prediction is provided mainly in an urban area, but an application target is not limited to a city. Flows passing between buildings and exhaust heat from the buildings, which are not considered in normal meteorological prediction, can be incorporated in micrometeorological prediction because of super-high-resolution. That is to say, micrometeorological prediction can simulate more close-to-reality atmospheric flows. Near-future micrometeorological prediction is considered to acquire observation data from sensors and cameras, drones, smartphones, or the like arranged in an environment such as a built-up area and perform prediction using these types of observation data. In order to perform such prediction with high accuracy, computational resolution needs to be raised.

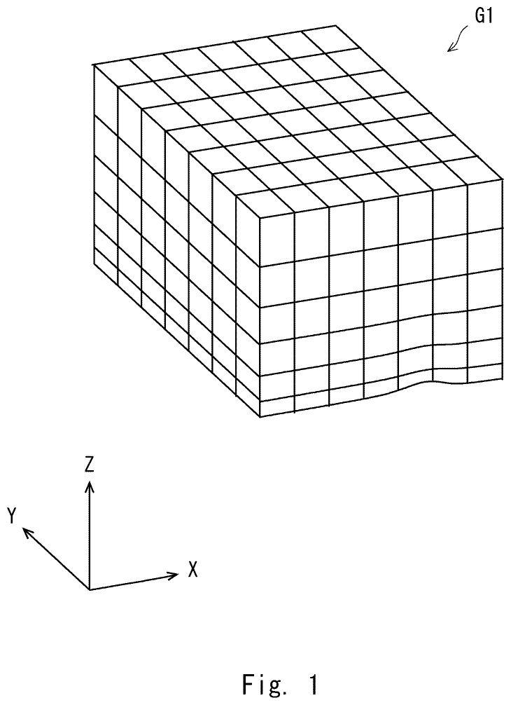

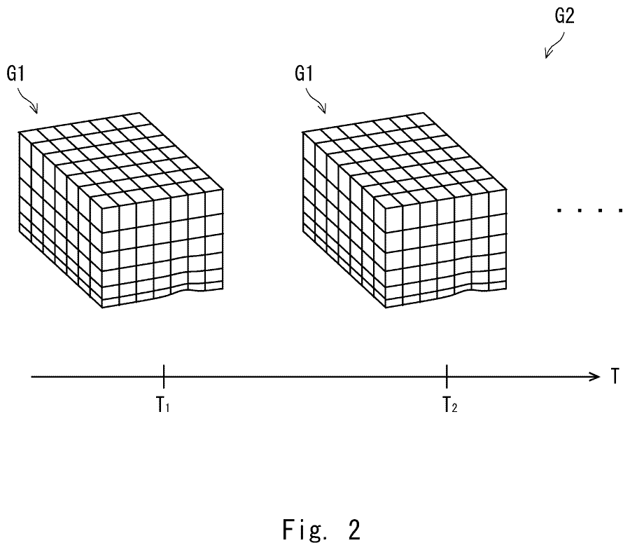

FIG. 1 and FIG. 2 are diagrams for describing computational resolution and grid data. FIG. 1 shows a three-dimensional computational mesh G1. The three-dimensional computational mesh G1 is expressed by a grid corresponding to a three-dimensional space defined by a three-dimensional coordinate space of an X-axis, a Y-axis, and a Z-axis. As an interval of this grid is shorter, computational resolution in a spatial direction becomes higher resolution. To the contrary, as the interval of the grid is longer, computational resolution in the spatial direction becomes lower resolution.

FIG. 2 shows a four-dimensional computational mesh G2. The four-dimensional computational mesh G2 is configured in such a manner that the three-dimensional computational meshes G1 are arranged in a temporal direction (indicated by a T-axis), that is, in a time series. Herein, as a time interval (a sampling period; an interval between T₁ and T₂ in FIG. 2) is shorter, computational resolution in the temporal direction becomes higher resolution. To the contrary, as the time interval is longer, computational resolution in the temporal direction becomes lower resolution. Note that although “space-time” will be described as four-dimensional space-time defined by a three-dimensional space and a one-dimensional time in the present embodiment, dimensionality of space-time is not limited to four-dimensionality.

Herein, data indicating numerical values of physical quantities or the like in the four-dimensional computational mesh G2 can be regarded as grid data in the four-dimensional space-time. The grid data indicates numerical values of physical quantities (such as speed) or the like defined on grid points arranged at a predetermined interval in space-time. That is, on each point of a three-dimensional space (the three-dimensional computational mesh G1), a numerical value (such as a physical quantity) indicating a state of the point exists, and the numerical value on each point shifts in the one-dimensional temporal direction as indicated by the four-dimensional computational mesh G2. The shift in the temporal direction of each point in the three-dimensional space is indicated by grid data. In this case, the grid data may be expressed by a four-dimensional data array (numerical value array) indicating numerical values of physical quantities or the like. The number of elements in the data array is called the number of elements. In addition, the data array may be provided for each physical quantity. In addition, the grid data can be called structured data having been structured. In addition, in a case in which grid data is handled by a neural network which will be described later, the grid data may indicate physical quantities that can be understood by humans, or may indicate numerical values that cannot be understood by humans. That is, the grid data has a structure indicating numerical values defined on grid points arranged at the predetermined interval in space-time.

On the other hand, if micrometeorological predictive simulation is performed at raised computational resolution, the amount of handled data increases, resulting in considerable computational cost. Therefore, it is considered to perform super resolution (SR) on a low-resolution (LR) simulation result, thereby obtaining a high-resolution (HR) computational result.

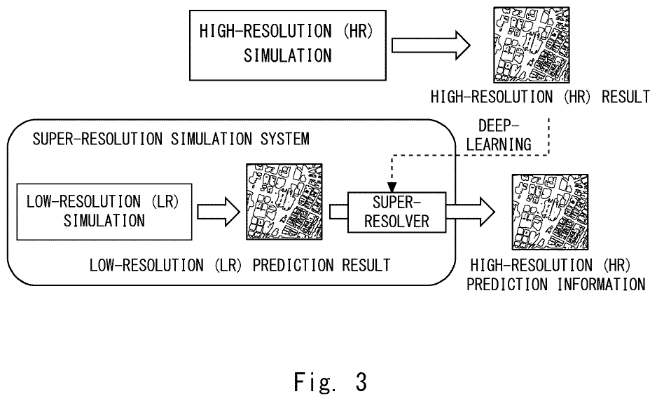

FIG. 3 is a diagram for describing a super-resolution simulation method. A super-resolution simulation system performs super-resolution with a super-resolver on a low-resolution prediction result obtained by performing low-resolution simulation. A high-resolution prediction result is thereby obtained. The super-resolver is trained by deep learning (a neural network) in advance using a high-resolution result obtained by high-resolution simulation. That is, the super-resolver is trained in advance by performing supervised learning using a large amount of high-resolution results as training data. Such a configuration enables a high-resolution prediction result to be obtained by performing low-resolution simulation during operation, which can lower computational cost.

In addition, in order to improve the accuracy of predictive simulation, it is considered to perform data assimilation on observation data and prediction results. The ensemble Kalman filter, which is one of data assimilation approaches, simulates many similar situations by ensemble computation and from variation in prediction results, estimates an error of the prediction results. The ensemble Kalman filter then determines a degree of bringing the prediction results closer to the observation data based on how large this error is. The prediction results can be brought closer to the observation data by performing data assimilation, which enables the accuracy of prediction results to be improved. Herein, the technology of Non Patent Literature 1 simply combines a super-resolution approach and a data assimilation approach as described above. That is, Non Patent Literature 1 performs super-resolution and data assimilation independently. Such an approach requires data assimilation to be performed by ensemble computation. Therefore, computational cost increases.

In contrast, in the present embodiment, super-resolution and data assimilation are executed simultaneously using time-series data which is grid data as will be described below. This eliminates the need to perform ensemble computation. Therefore, the present embodiment can perform prediction with high accuracy and efficiently.

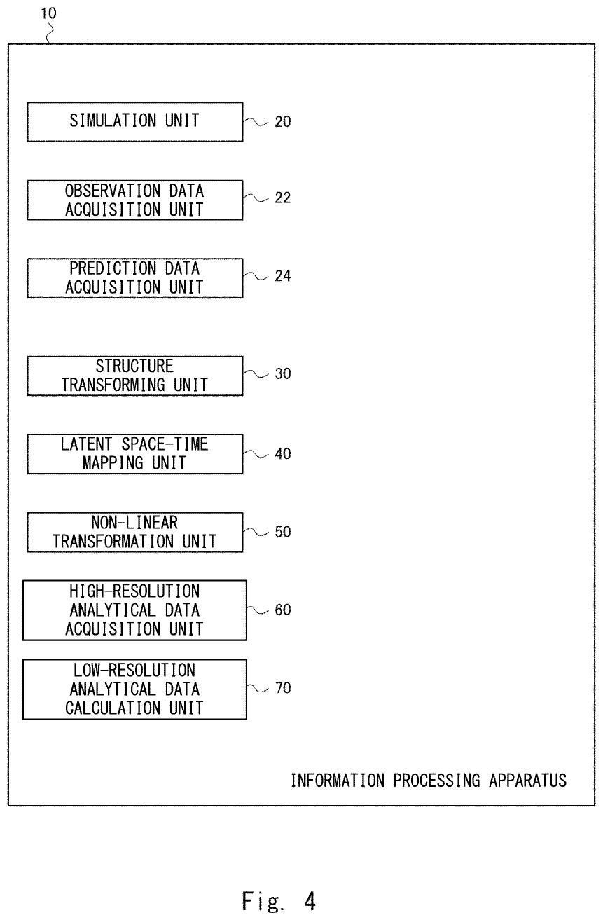

FIG. 4 is a diagram showing a configuration of an information processing apparatus 10 according to the present embodiment. The information processing apparatus 10 is a computer, for example. The information processing apparatus 10 has a simulation unit 20, an observation data acquisition unit 22, a prediction data acquisition unit 24, a structure transforming unit 30, a latent space-time mapping unit 40, a non-linear transformation unit 50, a high-resolution analytical data acquisition unit 60, and a low-resolution analytical data calculation unit 70. These constituent elements may be implemented by a hardware configuration which will be described later. Functionalities of these constituent elements will be described later.

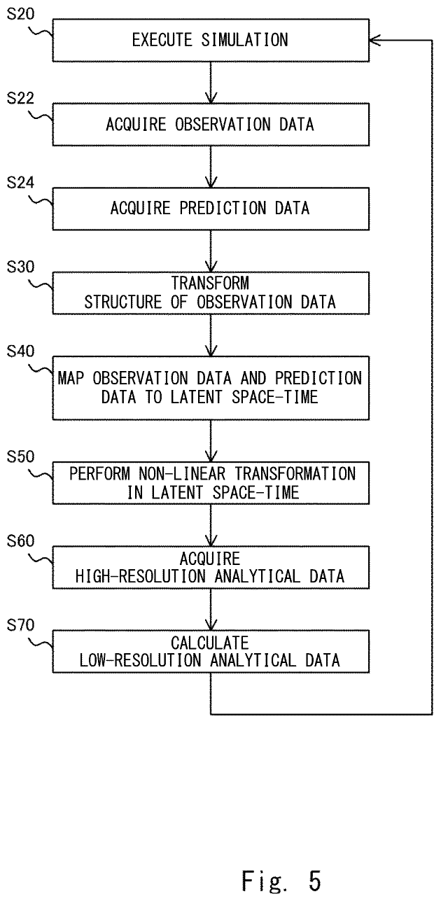

FIG. 5 is a flowchart showing an information processing method to be executed by the information processing apparatus 10 according to the present embodiment. The simulation unit 20 performs simulation of a state of an environment (step S20). Specifically, the simulation unit 20 performs low-resolution simulation as described above. More specifically, the simulation unit 20 performs low-resolution simulation in the temporal direction and spatial direction.

The observation data acquisition unit 22 acquires one or more types of observation data (step S22). The observation data is data obtained by observing a state in space-time. The observation data may be acquired from a sensor and a camera, a drone, a smartphone, or the like arranged in an environment, for example. Herein, the structure of the observation data does not need to be the structure of grid data. In addition, if the structure of the observation data is the structure of the grid data, the observation data has arbitrary resolution, and may be low-resolution or high-resolution. Details of the observation data will be described later.

The prediction data acquisition unit 24 acquires prediction data (step S24). Specifically, the prediction data acquisition unit 24 acquires prediction data which is a simulation result obtained by the simulation unit 20. Herein, the prediction data is time-series data indicating a temporal shift of a state. Alternatively, the prediction data is grid data in space-time obtained by simulation. The prediction data is prediction data in a time period (time series) at least including a time point of observation data and a past with respect to the time point. Herein, the “time point of observation data” includes the latest time point (reference time point) in all pieces of observation data. Details of the prediction data will be described later.

The structure transforming unit 30 transforms the structure of the observation data (step S30). Specifically, the structure transforming unit 30 transforms the structure of the observation data into observation data having the structure of the grid data. More specifically, the structure transforming unit 30 transforms the structure of the observation data which is data obtained by observing a state in space-time into observation data having the structure of grid data indicating numerical values defined on grid points arranged at a predetermined interval in the space-time. Details of a functionality of the structure transforming unit 30 will be described later.

The latent space-time mapping unit 40 maps the observation data and the prediction data to latent space-time (step S40). Specifically, the latent space-time mapping unit 40 maps the observation data transformed into the grid data in processing in S30 and the prediction data obtained by processing in S24 from first real space-time to the latent space-time. As will be described later, data assimilation of the observation data and the prediction data is performed by the latent space-time mapping unit 40 (processing in S40).

Herein, the latent space-time is space-time having a smaller number of elements than that in the first real space-time. In other words, the latent space-time is space-time having lower resolution than that in the first real space-time. Therefore, the number of elements in a data array in the latent space-time is smaller than the number of elements in a data array in the first real space-time. Data in the latent space-time may be configured by a numerical value array obtained by compressing temporal and spatial information for the observation data and the prediction data. Note that the latent space-time can be said to be a latent space including the concept of time (time series). In addition, dimensionality is not distinguished in the latent space-time. That is, in the latent space-time, time and space are not distinguished, and dimensionality of a three-dimensional space is not distinguished. In addition, the first real space-time is space-time corresponding to an environment in which the prediction data is obtained.

In addition, the latent space-time mapping unit 40 can acquire, by mapping to the latent space-time described above, data obtained by mapping the observation data (the observation data transformed into the grid data) to the latent space-time and data obtained by mapping (projecting) the prediction data to (on) the latent space-time. The latent space-time mapping unit 40 may map the prediction data to the latent space-time using the observation data transformed into the grid data. Therefore, “the data obtained by mapping the prediction data to the latent space-time” may include data obtained by mapping the observation data to the latent space-time. On the other hand, upon mapping the observation data, the latent space-time mapping unit 40 maps the observation data alone to the latent space-time.

Data assimilation of the observation data and the prediction data is performed by mapping the prediction data using the observation data transformed into the grid data. That is, upon mapped to the latent space-time, the observation data transformed into the grid data and the prediction data may be mixed (fused). In other words, in the latent space-time, the observation data transformed into the grid data is captured into the prediction data. A more detailed functionality of the latent space-time mapping unit 40 will be described later.

The non-linear transformation unit 50 performs non-linear transformation in the latent space-time (step S50). Specifically, the non-linear transformation unit 50 performs non-linear transformation in the latent space-time on the observation data and the prediction data having been mapped. More specifically, the non-linear transformation unit 50 may fuse the observation data and the prediction data mapped to the latent space-time to acquire data in the latent space-time (latent space-time data; fused data). Therefore, data assimilation of the observation data and the prediction data is performed by the non-linear transformation unit 50 (processing in S50). In addition, the non-linear transformation unit 50 may repeat non-linear transformation to make a distribution of numerical values of the latent space-time data mapped to the latent space-time discontinuous. Alternatively, the non-linear transformation unit 50 may make the distribution of numerical values of the latent space-time data mapped to the latent space-time complicate or simple by non-linear transformation. In this case, the non-linear transformation unit 50 may perform non-linear transformation such that super-resolution is performed appropriately. Note that the non-linear transformation unit 50 may not change the number of elements in a case of changing the distribution of numerical values. Note that super-resolution may be performed by increasing the number of elements. A more detailed functionality of the non-linear transformation unit 50 will be described later.

The high-resolution analytical data acquisition unit 60 acquires high-resolution analytical data (step S60). Specifically, the high-resolution analytical data acquisition unit 60 maps the observation data and the prediction data subjected to non-linear transformation from the latent space-time to second real space-time. The high-resolution analytical data acquisition unit 60 thereby acquires high-resolution analytical data. That is, the high-resolution analytical data is analytical data subjected to super-resolution in the temporal direction and the spatial direction.

Herein, the second real space-time is real space-time having a larger number of elements than that in the latent space-time and having higher resolution than that in the first real space-time. Therefore, the second real space-time can be said to be a high-resolution space (HR space). In addition, the high-resolution analytical data (HR analytical data) is grid data in space-time. In addition, the high-resolution analytical data is data having higher resolution in the space-time than that in the prediction data. Alternatively, the high-resolution analytical data may be time-series data in a time period (time series) including a past and a future with respect to a time point of the observation data. That is to say, in a case in which input prediction data exists into the future with respect to the time point (reference time point) of the observation data, the high-resolution analytical data is analytical data including a similar future time point. That is, the prediction data may be prediction data in a time period including the time point of the observation data and the past and the future with respect to the time point. In this case, the high-resolution analytical data acquisition unit 60 may acquire high-resolution analytical data in the time period including the past and the future with respect to the time point of the observation data. A more detailed functionality of the high-resolution analytical data acquisition unit 60 will be described later.

The low-resolution analytical data calculation unit 70 calculates low-resolution analytical data (step S70). Specifically, the low-resolution analytical data calculation unit 70 calculates low-resolution analytical data using the high-resolution analytical data. Herein, the low-resolution analytical data (LR analytical data) is analytical data having lower resolution in the space-time than that of the high-resolution analytical data. More specifically, the low-resolution analytical data calculation unit 70 subjects the high-resolution analytical data to an arithmetic operation (a mathematical approach) such as algebraic interpolation, thereby calculating the low-resolution analytical data. A more detailed functionality of the low-resolution analytical data calculation unit 70 will be described later.

The simulation unit 20 receives the low-resolution analytical data as input and performs next-timing simulation (S20). A processing flow shown in FIG. 5 is thereby repeated.

As described above, the information processing apparatus 10 according to the present embodiment is configured to perform data assimilation and super-resolution on the observation data in space-time and the low-resolution prediction data in space-time, to acquire the high-resolution analytical data. The information processing apparatus 10 is configured to, upon acquiring the high-resolution analytical data, perform processing in the latent space-time. Therefore, prediction of a state of an environment can be performed with high accuracy and efficiently.

The information processing apparatus 10 according to the present embodiment is also configured to calculate the low-resolution analytical data. This enables low-resolution simulation to be performed continually. Therefore, simulation can be performed efficiently.

In addition, the non-linear transformation unit 50 may perform data array deformation on data mapped to the latent space-time, thereby performing super-resolution in the temporal direction. In this case, the high-resolution analytical data acquisition unit 60 may perform super-resolution in the spatial direction on data on which super-resolution has been performed in the temporal direction in the latent space-time, independently for each time point in the temporal direction, thereby acquiring the high-resolution analytical data. This enables processing to be performed more efficiently. Details will be described later.

In addition, the structure transforming unit 30, the latent space-time mapping unit 40, the non-linear transformation unit 50, and the high-resolution analytical data acquisition unit 60 may be implemented by a trained model trained by a machine learning algorithm. In this case, the structure transforming unit 30, the latent space-time mapping unit 40, the non-linear transformation unit 50, and the high-resolution analytical data acquisition unit 60 may be implemented by a trained model trained by supervised learning using data having higher resolution in space-time than that of the prediction data as training data. Alternatively, the structure transforming unit 30, the latent space-time mapping unit 40, the non-linear transformation unit 50, and the high-resolution analytical data acquisition unit 60 may be implemented by a trained model trained by unsupervised learning in such a manner as to decrease a loss function. This enables the high-resolution analytical data to be acquired efficiently using observation data which is not grid data and low-resolution prediction data. Details will be described later.

### First Embodiment

Hereinafter, an embodiment will be described with reference to the drawings. For clarification of description, appropriate omission and simplification are performed in the following statement and the drawings. In addition, the same elements have the same reference characters allotted in the respective drawings, and repeated description will be omitted according to necessity.

### <Information Processing Apparatus>

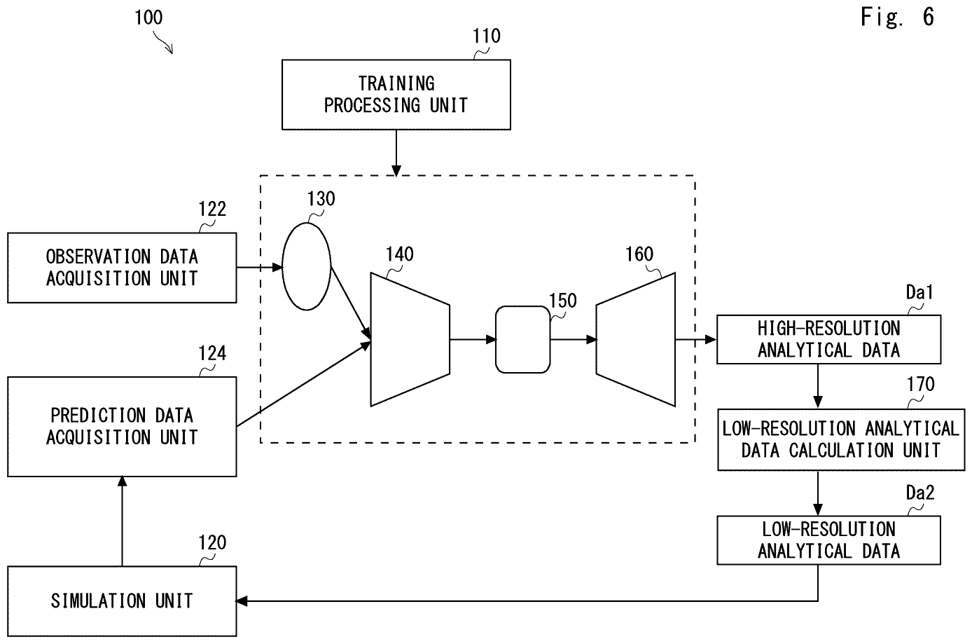

FIG. 6 is a diagram showing a configuration of an information processing apparatus 100 according to a first embodiment. The information processing apparatus 100 is a computer, for example. The information processing apparatus 100 has a training processing unit 110, a simulation unit 120, an observation data acquisition unit 122, a prediction data acquisition unit 124, a structure transforming unit 130, a latent space-time mapping unit 140, a non-linear transformation unit 150, a high-resolution analytical data acquisition unit 160, and a low-resolution analytical data calculation unit 170. These constituent elements may be implemented by a hardware configuration which will be described later.

The training processing unit 110 performs machine learning such as a neural network for the structure transforming unit 130, the latent space-time mapping unit 140, the non-linear transformation unit 150, and the high-resolution analytical data acquisition unit 160. This enables the structure transforming unit 130, the latent space-time mapping unit 140, the non-linear transformation unit 150, and the high-resolution analytical data acquisition unit 160 to implement their functionalities as a trained model.

Herein, upon performing machine learning, the training processing unit 110 may collectively train the structure transforming unit 130, the latent space-time mapping unit 140, the non-linear transformation unit 150, and the high-resolution analytical data acquisition unit 160 rather than training them separately. Specifically, the training processing unit 110 trains the structure transforming unit 130, the latent space-time mapping unit 140, the non-linear transformation unit 150, and the high-resolution analytical data acquisition unit 160 in an end-to-end manner by an end-to-end deep learning approach. That is, the training processing unit 110 performs machine learning with the functionality of each of the structure transforming unit 130, the latent space-time mapping unit 140, the non-linear transformation unit 150, and the high-resolution analytical data acquisition unit 160 regarded as a layer of a neural network. In other words, the training processing unit 110 performs machine learning assuming the structure transforming unit 130, the latent space-time mapping unit 140, the non-linear transformation unit 150, and the high-resolution analytical data acquisition unit 160 as a single neural network. Note that pretraining may be performed separately in each of the structure transforming unit 130, the latent space-time mapping unit 140, the non-linear transformation unit 150, and the high-resolution analytical data acquisition unit 160.

The training processing unit 110 may perform supervised learning, or may perform unsupervised learning. In the case of performing supervised learning, the training processing unit 110 may perform training using high-accuracy and high-resolution time-series meteorological data as training data, for example. Details of processing in the training processing unit 110 will be described later. Note that the structure transforming unit 130, the latent space-time mapping unit 140, the non-linear transformation unit 150, and the high-resolution analytical data acquisition unit 160 are not limited to being implemented as a trained model trained by machine learning performed by the training processing unit 110.

The simulation unit 120 corresponds to the simulation unit 20 described above. The simulation unit 120 performs low-resolution simulation in the temporal direction and the spatial direction. The simulation unit 120 generates low-resolution prediction data (simulation data) using an input initial state.

The low-resolution prediction data (LR predictive simulation data) is digital data defined on grid points in space-time. That is, the prediction data is grid data defined in the space-time. In other words, the prediction data has a data array defined by a grid structure. That is, the prediction data which is grid data in the space-time has a data array for each of grid points at a predetermined interval in the spatial direction and the temporal direction. In the four-dimensional computational mesh G2 shown in FIG. 2, grid points are aligned in a temporal axis direction. In the three-dimensional computational meshes G1 in the four-dimensional computational mesh G2, grid points are aligned in spatial three-axis directions. The grid data as the prediction data has a numerical value on each of the grid points. The interval between the grid points may be a regular interval or an irregular interval. Note that since the simulation unit 120 performs low-resolution simulation, the grid data as prediction data obtained has a longer interval in the temporal direction and a longer interval in the spatial direction on average than those in high-resolution grid data.

For example, let the prediction data be defined by a data array Aₕᵢⱼₖ in four-dimensional space-time. The subscript h corresponds to the temporal direction (t direction), the subscript i corresponds to the X-axis direction in the three-dimensional space, the subscript j corresponds to the Y-axis direction in the three-dimensional space, and the subscript k corresponds to the Z-axis direction in the three-dimensional space. At this time, the subscripts h, i, j, and k of the data array Aₕᵢⱼₖ take integer values. One grid point in the four-dimensional computational mesh G2 corresponds to one such set of integer values (h, i, j, k). The numerical value Aₕᵢⱼₖ on grid points can thereby be designated uniquely. In this manner, the prediction data is defined by the data array Aₕᵢⱼₖ having integer subscripts in the respective dimensional directions in the four-dimensional space.

Herein, let there be H elements in the temporal direction in the data array Aₕᵢⱼₖ. That is, let the subscript h take H values. Similarly, let there be I elements in the X-axis direction, that is, let the subscript i take I values. In addition, let there be J elements in the Y-axis direction, that is, let the subscript j take J values. In addition, let there be K elements in the Z-axis direction, that is, let the subscript k take K values. In this case, the number of elements in the data array Aₕᵢⱼₖ will be H*I*J*K. Let H=I=J=K=10 hold, then the number of elements in the data array Aₕᵢⱼₖ will be 10⁴.

The prediction data includes past temporal data in a time series. In addition, the prediction data may include future temporal data in the time series. In addition, as described above, the prediction data is temporal data including a time point (reference time point) of the observation data which will be described later.

The prediction data includes data indicating physical variables (physical quantities) required for predicting a state of an environment such as the atmosphere based on physical equations. In the case of meteorological predictive simulation, the above-described physical equations are, for example, Navier-Stokes equations for fluids, thermodynamic equations, or the like. In addition, the physical quantities are, for example, the speed of air, pressure, temperature, mixture ratio of water vapor, particle number density of cloud particles, and the like. The four-dimensional data array described above may be provided for each of these physical quantities. The data array can also be said to express a physical “field” of each of the physical quantities.

In addition, it should be noted that the prediction data (LR simulation result) is obtained by a single scenario in the present embodiment. That is, the prediction data is a singular (single) simulation result obtained in a case where simulation (physical simulation) is performed from a certain singular initial state. In contrast, data assimilation according to Non Patent Literature 1 performs simulation for various similar situations in order to perform ensemble computation. That is, Non Patent Literature 1 performs predictive simulation by a plurality of scenarios.

The prediction data acquisition unit 124 corresponds to the prediction data acquisition unit 24 described above. The prediction data acquisition unit 124 acquires the prediction data (a low-resolution physical simulation prediction result) described above from the simulation unit 120. The prediction data is expressed by Expression (1) below.

$$[ Expression 1 ]$$

$${\{ {x}_{t}^{L} \}}_{t = 0}^{n} \qquad ( 1 )$$

Herein, xₜ^{L} is a vector field consisting of all physical quantities in the prediction data. That is to say, x is a vector field indicating a set (vector) of values at respective grid points in the three-dimensional space at a certain time point t. Expression (1) indicates a class of vector fields of all physical quantities from the time point t=0 to the time point t=n. In other words, Expression (1) indicates all of data arrays (numerical value arrays) in four-dimensional space-time related to the prediction data. In addition, the superscript L indicates that the resolution is low in the spatial direction. In addition, t indicates a time stamp of the prediction data, and t indicates a time stamp of an interval in which the time interval is long. That is, t indicates that the resolution is low in the temporal direction (that is, the time interval is long). That is, Expression (1) expresses data having a small grid number in the four-dimensional space-time (having a small number of elements; low resolution).

The observation data acquisition unit 122 corresponds to the observation data acquisition unit 22 described above. The observation data acquisition unit 122 acquires observation data from a sensor and a camera, a drone, a smartphone, or the like arranged in an environment similarly to the observation data acquisition unit 22. The observation data is expressed by Expression (2) below.

[Expression 2]

{o_{τ}} (2)

Expression (2) indicates a class of digital data consisting of numerical values (observation values) o indicating a certain state at a time point τ. Herein, τ indicates a time stamp of the observation data. A time interval of t may not be a regular interval. In addition, o may indicate a physical quantity, or may not indicate a physical quantity. That is, o may indicate a numerical value of a non-physical quantity.

Note that the observation data may be grid data. Alternatively, the observation data does not need to be grid data. That is, the observation data may be unstructured data (non-grid data) not having been structured. In the observation data which is unstructured data, observation values are associated with temporal information and spatial information, but there is no regularity between respective intervals in time and space. That is, the observation data which is unstructured data does not have a spatial mesh structure. Therefore, the observation data may indicate observation values in random time and space.

In addition, the observation data may include various, miscellaneous pieces of data of different qualities. The observation data may be image data, sound data, point data, or log data. Alternatively, the observation data may be a class of values of physical quantities expressing a state of the atmosphere or digital data from which those physical quantities can be estimated. For example, the observation data may indicate observation values of Automated Meteorological Data Acquisition System (AMeDAS). In this case, the observation values may indicate temperature, humidity, wind velocity, and the like at various places. Alternatively, the observation data may indicate radiance of an object (such as a building). The temperature at a position in the vicinity of the object and at an observed time can thereby be estimated. Alternatively, the observation data may indicate an acceleration log of a flight vehicle such as a drone floating in the air. A wind velocity or turbulent dissipation rate at the position of the flight vehicle and at an observed time can thereby be estimated. Alternatively, the observation data may indicate an image captured by shooting the sky. Cloud cover or precipitation amount at a shot position and time can thereby be estimated. Alternatively, the observation data may indicate sales of frozen desserts (such as ice cream, sherbet, ice pop, and shaved ice) at a certain spot (such as a convenience store). A local temperature in the area can thereby be estimated. That is to say, as sales of frozen desserts increase, the temperature in the area may be estimated to be higher.

In addition, in a case in which sufficiently highly-accurate simulation is executed, a result of the simulation can be said to express a real state satisfactorily. Therefore, a result of the sufficiently highly-accurate simulation may be regarded as observation data assuming it as an observation result expressing the reality well. Note that depending on the settings, a “close-to-reality experiment” even with the shape of buildings and exhaust heat from the buildings captured can be performed as in micrometeorological simulation, for example. Such simulation has sufficiently small errors, and thus can be regarded as an observation result expressing the reality well, that is, observation data.

In addition, resolution of space-time in which the observation data is observed may be high-resolution or may be low-resolution. In a case in which the observation data indicates satellite data or radar data, they are obtained by linear (one-dimensional) observation or planar (two-dimensional) observation. Alternatively, in a case in which the observation data is data obtained by Doppler Lidar (LiDAR: Light Detection And Ranging), this is obtained by three-dimensional observation. In these cases, whether resolution of the observation data is low-resolution or high-resolution can be determined by spatial resolution (and a time interval of observation).

Alternatively, in a case in which the observation data corresponds to A MeDAS data, this is obtained by point (0-dimensional) observation. Even in this case, resolution can be defined as will be described below. That is to say, even in the point observation, there is a representative scale indicating which degree of scale of a state an observation value of the point observation represents. In a case of observation data having a large representative scale, it may be regarded as low-resolution observation data. In a case of observation data having a small representative scale, it may be regarded as high-resolution observation data. For example, a normal meteorological model observes observation values having coarse spatial resolution, such as representing horizontally 1 km to 10 km. Thus, strict conditions, such as a place in which there is no shielding object or the like nearby, a glassy area, non-exposure to direct sunlight or the like, and absence of an influence caused by anthropogenic heat, are imposed on observation. Such observation data can be said to be low-resolution observation data. On the other hand, a micrometeorological model can observe observation values having fine spatial resolution, such as representing horizontally 1 m to 5 m, which is influenced by anthropogenic heat. The micrometeorological model can perform simulation considering an influence on the atmosphere caused by such observation data. Such observation data can be said to be high-resolution observation data.

Note that high-resolution observation data and low-resolution prediction data are significantly different in resolution in the spatial direction and resolution in the temporal direction. Therefore, in the case in which data assimilation is performed, high-resolution observation data needs to be averaged in the space-time direction to be matched with low-resolution prediction data. Therefore, it should be noted that it is normally difficult to directly perform data assimilation on high-resolution observation data and low-resolution prediction data. In contrast, the present embodiment can perform data assimilation on arbitrary observation data and low-resolution prediction data.

The structure transforming unit 130 corresponds to the structure transforming unit 30 described above. The structure transforming unit 130 has a functionality as a structuralizer. The structure transforming unit 130 may be implemented by an existing structuralizer. The structure transforming unit 130 transforms observation data which is unstructured data (non-grid data) into observation data having the structure of grid data. That is, the structure transforming unit 130 converts the observation data into grid data. The structure transforming unit 130 transforms the observation data into data on respective grid points of grid data in high-resolution space-time. In other words, the structure transforming unit 130 transforms an observation value into a physical quantity defined on the grid. Note that grid data obtained by transforming the observation data may correspond to grid data having a larger number of elements (that is, higher resolution) than that of grid data as prediction data.

Let a function expressing the structuralizer implemented by the structure transforming unit 130 be s( ), then the functionality of the structure transforming unit 130 is expressed by Expression (3) below. The left side of Expression (3) corresponds to output data of the structure transforming unit 130. Note that observation data input to the structure transforming unit 130 (structuralizer) may be grid data. In addition, observation data input to the structuralizer may indicate a physical quantity, or may indicate a numerical value other than a physical quantity.

$$[ Expression 3 ]$$

$${\{ {o}_{T}^{H} \}}_{T = 0}^{N} = s ( \{ {o}_{τ} \} ) \qquad ( 3 )$$

Herein, o_{T}^{H} is a vector field consisting of all of observation values of observation data. That is to say, o is a vector field indicating a set (vector) of values on respective grid points in the three-dimensional space at a certain time point T. The left side of Expression (3) indicates a class of vector fields of all of observation values (such as physical quantities) from the time point T=0 to the time point T=N. In other words, the left side of Expression (3) indicates all of data arrays (numerical value arrays) in four-dimensional space-time corresponding to the observation data (such as physical quantities). In addition, the superscript H indicates that resolution is high in the spatial direction. In addition, T indicates a time stamp of the observation data. T indicates a time stamp of an interval having a short time interval. That is, T indicates that resolution is high in the temporal direction (that is, the time interval is short). That is, the left side of Expression (3) expresses data having a large grid number (a large number of elements; high resolution) in the four-dimensional space-time.

The structuralizer as the structure transforming unit 130 may be implemented by a trained model trained by machine learning, such as a neural network. In this case, the structure transforming unit 130 may be implemented by a linear projection operator, a fully-connected layer, or a graph convolutional network (the same applies to the latent space-time mapping unit 140, the non-linear transformation unit 150, the high-resolution analytical data acquisition unit 160 which will be described later). In this case, the structure transforming unit 130 is trained by the training processing unit 110. For example, the structuralizer may be implemented by the technology indicated by Non Patent Literature 2. As described above, the structure transforming unit 130, the latent space-time mapping unit 140, the non-linear transformation unit 150, and the high-resolution analytical data acquisition unit 160 are trained in an end-to-end manner by an end-to-end deep learning approach. The structure transforming unit 130 (structuralizer) is trained so as to transform observation data into grid data appropriate for performing super-resolution data assimilation according to the present embodiment.

Alternatively, the structuralizer may not be implemented by a trained model trained by machine learning. In this case, the structure transforming unit 130 may read a time point of and positional information about observation data and project the observation data on a grid point closest to the read time point and positional information among grid points arranged at a predetermined interval in space-time. In addition, in this case, the structure transforming unit 130 may substitute a missing value for a grid point on which the observation data is not projected.

Note that even in a case in which the observation data input to the structure transforming unit 130 is data indicating a non-physical quantity, the structure transforming unit 130 may output grid data indicating numerical values of a physical quantity or the like corresponding to the observation data. For example, in a case in which the observation data input to the structure transforming unit 130 is data indicating sales of frozen desserts at each time point at each spot, the structure transforming unit 130 may output grid data indicating the temperature at each time point at each spot. In addition, the structure transforming unit 130 may receive, as input, a plurality of various pieces of observation data. In this case, the structure transforming unit 130 may output grid data indicating numerical values of a physical quantity or the like corresponding to the plurality of pieces of observation data. For example, in a case in which the observation data input to the structure transforming unit 130 are acceleration of a drone and sales of frozen desserts at each time point at each spot, the structure transforming unit 130 may output grid data indicating wind velocity and temperature at each time point at each spot. In addition, the structure transforming unit 130 is not limited to outputting grid data indicating a physical quantity that can be understood by humans, which corresponds to the input observation data. The structure transforming unit 130 may output grid data corresponding to a numerical value array that cannot be understood by humans (that is, that can be understood only by a neural network). In other words, the structure transforming unit 130 outputs grid data (a numerical value array) indicating numerical values defined on grid points arranged at the predetermined interval in space-time. In addition, in a case in which the observation data is image data (camera data), the structure transforming unit 130 (or another constituent element) may perform processing utilizing object recognition or pixel segmentation as preprocessing. A pretrained neural network or the like may be utilized for this preprocessing. The structure transforming unit 130 may perform structure transforming processing described above on data subjected to such preprocessing.

As described above, the structure transforming unit 130 receives, as input, observation data which is non-grid data or grid data and which indicates observation values of a physical quantity or a non-physical quantity. The structure transforming unit 130 outputs grid data having a data array (numerical value array) in four-dimensional space-time related to a physical quantity (such as temperature or wind velocity) indicating a state of an environment (e.g., a state of the atmosphere). With such a configuration, the structure transforming unit 130 can transform observation data about a non-physical quantity or non-grid data, which cannot be handled by existing data assimilation approaches, by non-linear transformation into observation data about a numerical value array on which data assimilation can be performed.

The latent space-time mapping unit 140 corresponds to the latent space-time mapping unit 40 described above. The latent space-time mapping unit 140 has a functionality as an encoder. The latent space-time mapping unit 140 may be implemented by an existing encoder. The latent space-time mapping unit 140 maps observation data and prediction data in the first real space-time to latent space-time. The latent space-time mapping unit 140 transforms observation data structured in the four-dimensional space-time and prediction data into data in the latent space-time for each time point. That is, in the latent space-time mapping unit 140, output at each time point is computed independently for input at each time point.

Let a function expressing the encoder implemented by the latent space-time mapping unit 140 be eₓ( ), and eₒ( ), then the functionality of the latent space-time mapping unit 140 is expressed by Expression (4) and Expression (5) below. Herein, eₓ( ), is a function for mapping prediction data x to the latent space-time, and eₒ( ), is a function for mapping observation data o to the latent space-time. The observation data o and the prediction data x are each thereby mapped to the latent space-time at each time point t.

$$[ Expression 4 ]$$

$${p}_{t} = {e}_{x} ( {x}_{t}^{L} , {o}_{T}^{H} ) \qquad ( 4 )$$

$$[ Expression 5 ]$$

$${q}_{t} = {e}_{o} ( {o}_{T}^{H} ) \qquad ( 5 )$$

The latent space-time mapping unit 140 thereby obtains data in the latent space-time expressed by Expression (6) below. Expression (6) indicates a class of data in the latent space-time at respective time points from the time point t=0 to t=n.

$$[ Expression 6 ]$$

$${\{ {p}_{t} , {q}_{t} \}}_{t = 0}^{n} \qquad ( 6 )$$

Herein, Expression (4) indicates that mapping data pt is obtained by mapping the prediction data xₜ^{L} to the latent space-time using observation data oₜ transformed into grid data. The mapping data pt indicates a numerical value array in the latent space-time, which corresponds to low-resolution prediction data. Herein, the latent space-time mapping unit 140 may perform preprocessing and main processing on the observation data. As the preprocessing, for example, the latent space-time mapping unit 140 may transform the input observation data o_{T}^{H} into the observation data oₜ having a structure matched with a grid structure in space-time of the prediction data, where oₜ is obtained by roughening a time or space step of the observation data o_{T} transformed into the grid data to be matched with the grid structure of the low-resolution prediction data in the space-time. As the main processing, for example, the latent space-time mapping unit 140 may acquire the mapping data pt corresponding to the prediction data by simultaneous data assimilation of reflecting transformed oₜ in the low-resolution prediction data.

In addition, Expression (5) indicates that mapping data qₜ is obtained by mapping the observation data oₜ transformed into the grid data to the latent space-time. The mapping data qₜ indicates a numerical value array in the latent space-time, which corresponds to the observation data. Upon mapping the observation data, the latent space-time mapping unit 40 maps the observation data alone to the latent space-time.

Herein, as is also understood from the fact that the subscript is t in Expression (4) to Expression (6), resolution in the temporal direction (time step t) is matched with resolution of the prediction data in the latent space-time mapping unit 140 in the processing of the latent space-time mapping unit 140. On the other hand, resolution in the spatial direction is smaller than resolution of the prediction data. That is, as described above, the number of elements in the numerical value array of mapping data in the latent space-time is smaller than the number of elements in the numerical value array of the prediction data. Therefore, the latent space-time mapping unit 140 performs reduction of the number of elements in the numerical value arrays of the observation data and the prediction data (dimensional compression in a phase space).

Expression (4) to Expression (6) also indicate that the observation data and the prediction data are fused in the latent space-time. That is, Expression (6) indicates data (fused data) obtained by fusing the observation data and the prediction data in the latent space-time. Therefore, it can be said that data assimilation is performed on the observation data and the prediction data by the latent space-time mapping unit 140.

The latent space-time mapping unit 140 (encoder) may be implemented by a trained model trained by machine learning, such as a neural network. For example, the latent space-time mapping unit 140 may reduce the number of elements while performing non-linear transformation using convolution and pooling. In addition, the neural network may be a neural network reflecting physical symmetry. In order to reflect spatial translation symmetry, a convolutional neural network may be employed. Alternatively, in order to reflect spatial rotational symmetry, group/convolutional neural network may be employed. Alternatively, in order to reflect relabeling symmetry, a vision transformer or a graph convolutional neural network may be employed. Transformation considering physical symmetry can thereby be performed unlike the existing data assimilation approaches. This also applies to a decoder as the high-resolution analytical data acquisition unit 160 which will be described later.

As described above, the latent space-time mapping unit 140 receives, as input, the low-resolution prediction data and the observation data transformed into the grid data, which are sets of data arrays in the four-dimensional space-time. The latent space-time mapping unit 140 outputs mapping data in the latent space-time having a small number of elements. With such a configuration, the latent space-time mapping unit 140 can improve processing efficiency in the non-linear transformation unit 150 and the high-resolution analytical data acquisition unit 160. That is to say, the number of elements in the numerical value array is reduced, whereby the amount of data to be processed is lessened. Therefore, throughput of a computational resource is lowered.

The non-linear transformation unit 150 corresponds to the non-linear transformation unit 50 described above. The non-linear transformation unit 150 has a functionality as a time-series transformer. The non-linear transformation unit 150 may be implemented by an existing time-series transformer. The non-linear transformation unit 150 performs non-linear transformation in the latent space-time on the observation data and the prediction data having been mapped. More specifically, the non-linear transformation unit 150 may perform non-linear transformation in a time series to generate data obtained by fusing the observation data and the prediction data mapped to the latent space-time. The non-linear transformation unit 150 according to the first embodiment may perform super-resolution on the fused data in the temporal direction. Herein, the number of elements has been reduced in the latent space-time as compared with the real space-time as described above. Therefore, the amount of data to be processed is lowered, whereby super-resolution can be performed efficiently in the temporal direction.

Let a function expressing the time-series transformer implemented by the non-linear transformation unit 150 be F( ), then the functionality of the non-linear transformation unit 150 is expressed by Expression (7) below. The left side of Expression (7) corresponds to output data of the non-linear transformation unit 150. As described above, the subscript T indicates that resolution is high in the temporal direction, and r_{T} indicates data (fused data) at the time point T obtained by fusing the observation data and the prediction data mapped to the latent space-time by data assimilation. The left side of Expression (7) indicates a class of fused data from the time point T=0 to the time point T=N. In other words, the left side of Expression (7) indicates a data array (a numerical value array) in the four-dimensional space-time corresponding to the fused data.

$$[ Expression 7 ]$$

$${\{ {r}_{T} \}}_{T = 0}^{N} = F ( {\{ {p}_{t} , {q}_{t} \}}_{t = 0}^{n} ) \qquad ( 7 )$$

As described above, Expression (7) indicates that the observation data and the prediction data have been fused in the latent space-time. That is, the left side of Expression (7) indicates data (fused data) obtained by fusing the observation data and the prediction data in the latent space-time. Therefore, it can be said that data assimilation is performed on the observation data and the prediction data by the non-linear transformation unit 150.

The time-series transformer as the non-linear transformation unit 150 may be implemented by a trained model trained by machine learning, such as a neural network. In this case, the non-linear transformation unit 150 may be implemented by a neural network utilizing an attention mechanism. In addition, the time-series transformer as the non-linear transformation unit 150 may perform non-linear transformation using a technology of Transformer stated in Non Patent Literature 3, for example.

In addition, the non-linear transformation unit 150 may implicitly compute a prediction error utilizing information about the space-time direction. That is, the non-linear transformation unit 150 may compute an error within the neural network from a temporal shift in a space pattern. In other words, the non-linear transformation unit 150 may perform matching of space-time patterns to discriminate how large an error with respect to ground truth data is, thereby calculating a prediction error. The non-linear transformation unit 150 may be implemented by such a neural network in which data assimilation is performed on the prediction data and the observation data using the prediction error as an weight. Data assimilation may thereby be performed on the prediction data and the observation data by efficient computation in which ensemble is not required.

Alternatively, the time-series transformer as the non-linear transformation unit 150 may repeatedly execute linear transformation (e.g., affine transformation) and non-linear transformation by a rectified linear unit (ReLU). In the procedure of executing this processing, the non-linear transformation unit 150 may deform a data array so as to fine a time step using the technology of Non Patent Literature 4, for example. The non-linear transformation unit 150 may divide a plurality of elements in the latent space-time into two, elements in the temporal direction and elements in the spatial direction, to increase the number of elements in the temporal direction. For example, let there be H′ elements in the temporal direction, I′ elements in the X-axis direction, J′ elements in the Y-axis direction, and K′ elements in the Z-axis direction. In this case, the non-linear transformation unit 150 deforms a four-dimensional array H′×I′×J′×K′ into a two-dimensional array H′×M. Note that M is the number of elements in the spatial direction, and M=I′×J′×K′ holds. The non-linear transformation unit 150 may deform this array into an array of 2H′×M/2. Accordingly, the number of elements in the temporal direction increases twofold, and the time step is reduced by half. Therefore, this means that super-resolution is performed in the temporal direction on data mapped to the latent space-time. In this manner, the non-linear transformation unit 150 may perform data array deformation on the data mapped to the latent space-time, thereby performing super-resolution in the temporal direction.

As described above, the non-linear transformation unit 150 receives, as input, a set of numerical value arrays (data arrays) corresponding to the observation data and the prediction data in the latent space-time. The non-linear transformation unit 150 may output time-series data in the latent space-time, on which super-resolution has been performed in the temporal direction. Resolution in the temporal direction of this time-series data in the latent space-time on which super-resolution has been performed in the temporal direction is higher than resolution of the prediction data in the temporal direction. The non-linear transformation unit 150 thereby performs super-resolution in the temporal direction in the latent space-time having a small number of elements (that is, having a low dimension in a phase space), whereby computational effort can be reduced, and processing cost can therefore be lessened. Therefore, computation efficiency can be raised.

In addition, super-resolution in the temporal direction is performed by the time-series transformer as the non-linear transformation unit 150. As described above, a required amount of memory is saved because of the small number of elements in the numerical value array in the latent space-time, whereby a long time series can be handled. Super-resolution in the temporal direction can thereby be performed efficiently. The processing in the non-linear transformation unit 150 enables data assimilation of the observation data and the prediction data to be performed while performing super-resolution in the temporal direction. Therefore, data assimilation and super-resolution in the temporal direction can be performed efficiently.

The high-resolution analytical data acquisition unit 160 corresponds to the high-resolution analytical data acquisition unit 60 described above. The high-resolution analytical data acquisition unit 160 has a functionality as a decoder. The high-resolution analytical data acquisition unit 160 may be implemented by an existing decoder. The high-resolution analytical data acquisition unit 160 maps the observation data and the prediction data subjected to non-linear transformation from the latent space-time to the second real space-time. The high-resolution analytical data acquisition unit 160 maps data obtained by the processing in the non-linear transformation unit 150 for each time point from the latent space-time to the second space-time. The high-resolution analytical data acquisition unit 160 thereby performs super-resolution in the spatial direction on the data obtained by the processing in the non-linear transformation unit 150. The high-resolution analytical data acquisition unit 160 thereby transforms data in the latent space-time to high-resolution analytical data for each time point. That is, in the high-resolution analytical data acquisition unit 160, output at each time point is computed independently for input at each time point.

The high-resolution analytical data acquisition unit 160 acquires high-resolution analytical data Da1 in this manner. As described above, the high-resolution analytical data Da1 is data having higher resolution in space-time than that of the prediction data. In addition, the high-resolution analytical data Da1 may be analytical data in a time period (time series) including a past and a future with respect to a time point of the observation data in accordance with a time point range of input prediction data. Therefore, the high-resolution analytical data Da1 may be analytical data obtained by subjecting the time point (reference time point) of the observation data to extrapolation (temporal extrapolation) in the temporal direction.

Let a function expressing the decoder implemented by the high-resolution analytical data acquisition unit 160 be d( ), then the functionality of the high-resolution analytical data acquisition unit 160 is expressed by Expression (8) below, where d( ), is a function for mapping the fused data r_{T} related to the time point T from the latent space-time to the second real space-time. The fused data obtained by fusing the observation data and the prediction data by data assimilation is thereby mapped to the high-resolution second real space-time at each time point T. Super-resolution in the spatial direction is thereby performed on the fused data on which super-resolution has been performed in the temporal direction by the non-linear transformation unit 150.

$$[ Expression 8 ]$$

$${y}_{T}^{H} = d ( {r}_{T} ) \qquad ( 8 )$$

The high-resolution analytical data acquisition unit 160 thereby obtains data in the second real space-time expressed by Expression (9) below. Expression (9) indicates a class of high-resolution analytical data y at respective time points from the time point T=0 to T=N. Expression (9) corresponds to the high-resolution analytical data Da1 which is output data of the high-resolution analytical data acquisition unit 160. The high-resolution analytical data indicated by Expression (9) is time-series data on a high-resolution grid. The high-resolution analytical data Da1 may include past, current, and future data.

$$[ Expression 9 ]$$

$${\{ {y}_{T}^{H} \}}_{T = 0}^{N} \qquad ( 9 )$$

Herein, y_{T}^{H} is a vector field consisting of all physical quantities in the high-resolution analytical data. That is to say, y is a vector field indicating a set (vector) of values on the respective grid points in the three-dimensional space at the certain time point T. Expression (9) indicates a class of vector fields of all physical quantities from the time point T=0 to the time point T=N. In other words, Expression (9) indicates all of data arrays (numerical value arrays) in the four-dimensional space-time related to the high-resolution analytical data. In addition, the superscript H indicates that resolution is high in the spatial direction. In addition, T indicates a time stamp of the high-resolution analytical data. T indicates a time stamp of an interval having a short time interval. That is, T indicates that resolution is high in the temporal direction (that is, the time interval is short). That is, Expression (9) expresses data having a large grid number (a large number of elements; high resolution) in the four-dimensional space-time.

The decoder as the high-resolution analytical data acquisition unit 160 may be implemented by a trained model trained by machine learning, such as a neural network. For example, a neural network related to the high-resolution analytical data acquisition unit 160 may be a neural network reflecting physical symmetry. This enables transformation considering physical symmetry unlike the existing data assimilation approaches. In addition, the high-resolution analytical data acquisition unit 160 may generate high-resolution analytical data obtained by performing extrapolation (temporal extrapolation) in the temporal direction on the time point (reference time point) of the observation data by the neural network. That is to say, the neural network as the high-resolution analytical data acquisition unit 160 may be trained so as to output high-resolution analytical data obtained by performing temporal extrapolation on the reference time point using, as training data, time-series data having higher resolution and higher accuracy in the space-time than that of the prediction data.

Alternatively, the decoder as the high-resolution analytical data acquisition unit 160 may repeatedly execute linear transformation and non-linear transformation (e.g., ReLU) to increase resolution in the spatial direction. In the procedure of executing this processing, the high-resolution analytical data acquisition unit 160 may deform the data array (numerical value array) so as to increase resolution in the spatial direction using a technology called Pixel Shuffle indicated in Non Patent Literature 5, for example. At this time, let the fused data be a numerical value array in which the number of elements in the temporal direction is n and in which the number of elements in the spatial direction is m, for example. In this case, the high-resolution analytical data acquisition unit 160 may deform an array of n×m to an array of n/2×2m. The number of elements in the spatial direction thereby increases twofold (m→2m), and thus, resolution in the spatial direction is doubled.

As described above, the high-resolution analytical data acquisition unit 160 receives, as input, a numerical value array (data array) which is time-series data in the latent space-time, which corresponds to the fused data. The high-resolution analytical data acquisition unit 160 outputs a four-dimensional numerical value array which is time-series data on a high-resolution grid in the second real space-time having a large number of elements. With such a configuration, the high-resolution analytical data acquisition unit 160 can efficiently perform super-resolution in the spatial direction in the real space-time on the fused data on which data assimilation and super-resolution in the temporal direction have been performed.

That is to say, the high-resolution analytical data acquisition unit 160 independently processes a numerical value array (fused data) in the latent space-time at each time point. In the processing in the high-resolution analytical data acquisition unit 160, super-resolution in the spatial direction can thereby be performed without referring to information about the temporal direction. Therefore, a required computational resource (such as an amount of memory) is saved in the processing in the high-resolution analytical data acquisition unit 160, whereby super-resolution in the three-dimensional space can be performed efficiently. Therefore, high-resolution analytical data subjected to super-resolution in the temporal direction and the spatial direction can be obtained efficiently. In addition, in a case in which the prediction data is prediction data in a time period including the time point of the observation data and the past and the future with respect to the time point, the high-resolution analytical data acquisition unit 160 may acquire high-resolution analytical data in a time period including the past and the future with respect to the time point of the observation data. Future prediction information subjected to temporal extrapolation can thereby be provided simultaneously with provision of the high-resolution analytical data. Therefore, a service with higher added value can be provided.

In addition, in a case where the high-resolution analytical data subjected to super-resolution in the temporal direction and the spatial direction is obtained, low-resolution predictive simulation can be supplemented as will be described below. That is to say, practically, resolution of predictive simulation such as meteorological/oceanographic phenomena prediction is insufficient in the temporal direction and the spatial direction in many cases. In the aquaculture industry, for example, the activity of fish gains if the water temperature rises. Thus, the fish, if fed excessively, might suddenly die from lack of oxygen. Therefore, an aquaculture producer may desire to know timing of a water temperature rise in order to adjust a feed dosage. However, in the case of current oceanographic forecasting, resolution in the planar direction is relatively low resolution of approximately 10 km. Predictive simulation at this level of resolution might fail to predict the water temperature in the neighborhood of a fish preserve of the aquaculture producer with high accuracy. In order to predict the water temperature of a fish preserve of each aquaculture producer with high accuracy, fine resolution (high resolution) of at least 1 km, or approximately 100 m if possible, is required. In contrast, since the present embodiment can acquire the high-resolution analytical data subjected to super-resolution in the temporal direction and the spatial direction, information can be provided with high accuracy for a producer who desires to know pinpoint meteorological/oceanographic phenomena prediction.

The low-resolution analytical data calculation unit 170 corresponds to the low-resolution analytical data calculation unit 70 described above. The low-resolution analytical data calculation unit 170 calculates low-resolution analytical data Da2 using the high-resolution analytical data Da1. Note that resolution of the low-resolution analytical data Da2 may correspond to resolution of prediction data. The low-resolution analytical data Da2 is grid data having a data array having lower resolution than that of the high-resolution analytical data Da1. In addition, the low-resolution analytical data Da2 may be snapshot data at a certain time point. Specifically, the low-resolution analytical data calculation unit 170 uses a function f(y) determined in advance and inputs the high-resolution analytical data y described above to the function f, thereby calculating the low-resolution analytical data Da2. The function f may be a function expressing algebraic interpolation, for example. The function f may be a function for performing an algebraic interpolation operation such as linear interpolation. Alternatively, the function f may be a function defined by the linear interpolation method, bicubic method, or Lanczos method. For example, the low-resolution analytical data calculation unit 170 can calculate the low-resolution analytical data Da2 from the high-resolution analytical data Da1 by resizing the high-resolution analytical data (reducing resolution). Specifically, the low-resolution analytical data calculation unit 170 locally interpolates a value corresponding to each grid point in grid data by a polynomial expression to scale up or scale down the grid data. The low-resolution analytical data Da2 is thereby calculated.

As described above, the low-resolution analytical data Da2 is utilized for performing next-timing predictive simulation by being input to the simulation unit 120. Alternatively, the low-resolution analytical data Da2 may be utilized for numerically solving a physical equation to obtain future prediction. Time evolution of a state of predictive simulation can thereby be performed. In this case, the low-resolution analytical data Da2 may indicate a state of the current time point.

The information processing apparatus 100 according to the first embodiment is configured to perform data assimilation and super-resolution in the latent space-time having a reduced number of elements as described above. Processing can thereby be performed with the number of elements to be handled in computation, that is, the amount of data, reduced. Thus, data assimilation and super-resolution can be performed efficiently. Therefore, observation data indicating a non-physical quantity and observation data which is irregular in the temporal and spatial directions can be assimilated efficiently to prediction data. In addition, in the case of training the structure transforming unit 130, the latent space-time mapping unit 140, the non-linear transformation unit 150, and the high-resolution analytical data acquisition unit 160 in an end-to-end manner in the training processing unit 110 by an end-to-end training approach as described above, many computational resources are required. Therefore, such training can be performed efficiently by performing processing in the latent space-time as described above to thereby reduce the amount of data to be processed.

The information processing apparatus 100 according to the first embodiment is also configured to perform super-resolution in the temporal direction in the non-linear transformation unit 150 and to perform super-resolution in the spatial direction in the high-resolution analytical data acquisition unit 160. Super-resolution in the temporal direction and the spatial direction can thereby be performed efficiently. That is to say, in order to simultaneously perform super-resolution both in the temporal direction and the spatial direction, a large amount of memory and computing time period are required. Particularly in a training stage, computational graphs and gradient values need to be stored for error backpropagation. Therefore, a huge amount of memory and computing time period are required. In contrast, in the information processing apparatus 100 according to the first embodiment, the non-linear transformation unit 150 efficiently refers to dimensionality of the temporal direction for performing super-resolution in the temporal direction in the latent space-time having a small number of elements. On the other hand, the high-resolution analytical data acquisition unit 160 is not required to consider dimensionality of the temporal direction as it processes a snapshot at each time point. Furthermore, since a snapshot at each time point is processed, these snapshots can be processed simultaneously. Therefore, required computational resources can be lowered.

### Comparison with Comparative Example

A comparative example according to Non Patent Literature 1 and the technology according to the first embodiment will now be compared.

As described above, the technology of Non Patent Literature 1 simply combines a super-resolution approach and a data assimilation approach. That is, Non Patent Literature 1 performs super-resolution and data assimilation independently.

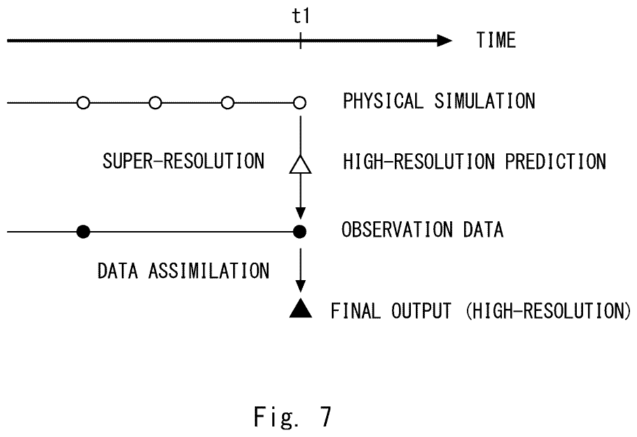

FIG. 7 is a diagram for describing the technology according to the comparative example. FIG. 7 describes the technology according to Non Patent Literature 1 as the comparative example. In the comparative example, physical simulation is executed for various situations by ensemble computation as indicated by white circular dots. As indicated by black circular dots, let there be observation data at a time point t1. In this case, as indicated by white triangular dots, super-resolution is performed using a physical simulation result at the time point t1, and high-resolution prediction is performed. This super-resolution is performed independently on an ensemble computation result, that is to say, on each of the respective situations, at the time point t1. Data assimilation is performed at the time point t1 on a high-resolution ensemble prediction result and observation data, and as indicated by black triangular dots, high-resolution prediction data assimilated to the observation data is obtained as a final output. In this manner, the comparative example utilizes ensemble computation. In addition, in the comparative example, super-resolution at a certain moment is performed independently from data assimilation at the same moment. Data assimilation is performed in a high-resolution space.

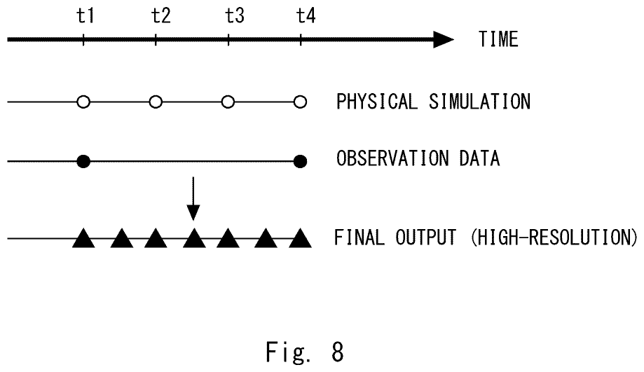

FIG. 8 is a diagram for describing super-resolution and data assimilation according to the first embodiment. The first embodiment utilizes a single scenario. That is, physical simulation is performed from a singular initial state to obtain a singular simulation result in a time series as indicated by white circular dots. In FIG. 8, a physical simulation result (prediction data) which is time-series data corresponding to the time points t1, t2, t3, and t4 is obtained. Rather than performing super-resolution at a certain time point, super-resolution and data assimilation are performed simultaneously in latent space-time having a reduced number of elements receiving, as input, observation data indicated by black circular dots and prediction data which is time-series data. High-resolution data which is time-series data is thereby obtained as indicated by black triangular dots. In addition, as shown in FIG. 8, the high-resolution data has higher resolution in the temporal direction than that in the physical simulation. In this manner, the first embodiment does not perform ensemble computation in simulation unlike the comparative example. In addition, the first embodiment performs super-resolution and data assimilation simultaneously in the latent space-time unlike the comparative example. In addition, the first embodiment utilizes time-series information to perform super-resolution and data assimilation unlike the comparative example.

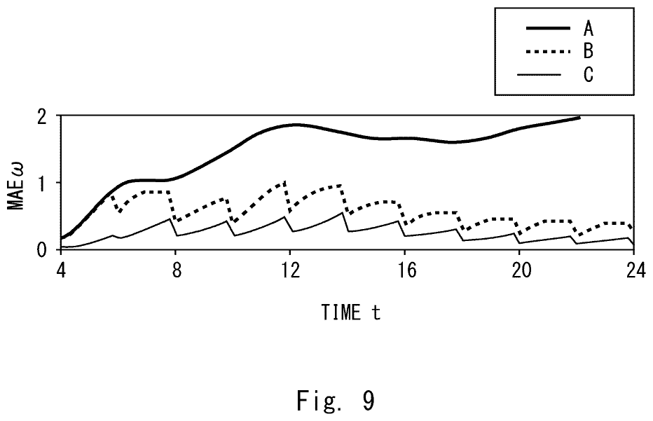

FIG. 9 is a comparative diagram of an experimental result according to the first embodiment and an experimental result according to the comparative example. FIG. 9 is a diagram showing a time series of mean absolute error (MAE) of a vorticity field ω. A graph A shows a case in which neither data assimilation nor super-resolution is performed. A graph B shows a case of the comparative example. A graph C shows a case of the first embodiment. As shown in FIG. 9, an error is minimum in the case of the first embodiment. Therefore, the technology according to the first embodiment can implement high-accuracy prediction.

In addition, in the experimental result according to the comparative example, a computing time period per experiment was 320 seconds. In contrast, in the experimental result according to the first embodiment, a computing time period per experiment is 61 seconds. In this manner, the technology according to the first embodiment can implement considerable shortening of the computing time period as compared with the comparative example.

### <Training Method>

A training method performed by the training processing unit 110 of the information processing apparatus 100 according to the first embodiment will now be described. As described above, the training processing unit 110 trains the structure transforming unit 130, the latent space-time mapping unit 140, the non-linear transformation unit 150, and the high-resolution analytical data acquisition unit 160 in an end-to-end manner by an end-to-end training approach. That is, the training processing unit 110 may train the structure transforming unit 130, the latent space-time mapping unit 140, the non-linear transformation unit 150, and the high-resolution analytical data acquisition unit 160 assuming them as a single neural network in which they serve as respective layers. In other words, the training processing unit 110 collectively trains the structure transforming unit 130, the latent space-time mapping unit 140, the non-linear transformation unit 150, and the high-resolution analytical data acquisition unit 160 using observation data and prediction data as input such that appropriate high-resolution analytical data is output.

First, a first training method will be described. The first training method is supervised learning. Training data (ground truth data) is high-accuracy and high-resolution data, for example. In a case of a system that performs meteorological prediction, training data is high-accuracy and high-resolution meteorological data, for example. That is, the training data is high-accuracy and high-resolution time-series data about atmospheric physical variables. The training data is time-series data (a four-dimensional numerical value array) about velocity field, temperature field, density field, or the like, for example. Alternatively, a super-high-resolution micrometeorological simulation result may be used as the training data. The training processing unit 110 receives, as input, the prediction data and the observation data described above and updates, by error backpropagation, parameters (such as weights) of the neural network in a gradient direction of an error between the training data and a final output (high-resolution analytical data) using the training data described above. The training processing unit 110 repeats such processing, thereby training the neural network constituting the structure transforming unit 130, the latent space-time mapping unit 140, the non-linear transformation unit 150, and the high-resolution analytical data acquisition unit 160.

A second training method will now be described. The second training method is unsupervised learning. In the supervised learning described above, high-accuracy and high-resolution time-series data about atmospheric physical variables, for example, are required as the training data. However, it may be difficult to gain such data. In contrast, unsupervised learning does not require such training data. The unsupervised learning may be performed by a variational Bayesian method, for example. Alternatively, the unsupervised learning may be performed by adversarial learning. Hereinafter, a training method by the variational Bayesian method will be described.

The variational Bayesian method is a kind of approximation method and approximates a true probability distribution p by a simple probability distribution q. The parameter q is estimated by KL divergence minimization or the like. The variational Bayesian method is a probabilistic model that brings a true physical variable of a state of an environment such as the atmosphere into a hidden state and based on this hidden state, gives an input observation value or low-resolution prediction value.

As one of implementation examples of the variational Bayesian method, a lower bound of a log likelihood ln(p(o|x)) is introduced, and this lower bound is maximized. The log likelihood ln(p(o|x)) can be deformed as in Expression (10) below utilizing Jensen's inequality. Herein, o corresponds to the observation data, and x corresponds to the low-resolution prediction data. During deformation of Expression (10), a hidden variable y is introduced. This hidden variable corresponds to the high-resolution analytical data Da1 indicated by Expression (9). As a result, a loss function that enables estimation of the hidden variable y from the observation data o and the low-resolution prediction x.

$$[ Expression 10 ]$$

$$\begin{matrix}ln p ( o \vert x ) = ln \int p ( o \vert x , y ) p ( y \vert x ) dy \\ = ln \int [ \frac{p ( o \vert x , y ) p ( y \vert x )}{q ( y \vert x , o )} q ( y \vert x , o ) ] dy \geq \\ \int [ ln \frac{p ( o \vert x , y ) p ( y \vert x )}{q ( y \vert x , o )} ] q ( y \vert x , o ) dy \\ = {𝔼}_{q} [ p ( o \vert x , y ) ] - K L ( q ( y \vert x , o ) \vert p ( y \vert x ) )\end{matrix} \qquad ( 10 )$$

In Expression (10), the observation value o corresponds to low-resolution or high-resolution observation data, and o corresponds to Expression (2) (or the left side of Expression (3)) described above. In addition, the hidden variable y corresponds to the high-resolution analytical data Da1. Note that the observation value o may be high-accuracy prediction data. The variable x corresponds to input low-resolution prediction data (Expression (1)). In addition, this probabilistic model is composed of a recognition model and a generative model. The recognition model (a portion in which the hidden variable is calculated) corresponds to the structure transforming unit 130, the latent space-time mapping unit 140, the non-linear transformation unit 150, and the high-resolution analytical data acquisition unit 160 (encoder/decoder model) in the information processing apparatus 100. The generative model will be described later.

The fourth expression (the rightmost side; the final form of deformation) in Expression (10) corresponds to a variational lower bound (VLB) which is the lower bound of the log likelihood. A first term E_{q}[p(o|x,y)] of the variational lower bound indicates a reconstruction error and corresponds to a log likelihood of the observation data o. A second term KL(q(y|x,o)|p(y|x)) of the variational lower bound indicates KL divergence. KL divergence is an index corresponding to a distance between the distribution q and the distribution p.

The training processing unit 110 updates model parameters (parameters of the neural network) by error backpropagation and gradient descent so as to maximize (heighten) the variational lower bound indicated by the fourth expression in Expression (10) and performs training. This variational lower bound corresponds to a training error. Maximizing the variational lower bound corresponds to minimizing the loss function in machine learning. In other words, heightening the variational lower bound corresponds to decreasing the loss function in machine learning. At this time, training progresses so as to strike a balance between the reconstruction error and KL divergence. This striking a balance between the reconstruction error and KL divergence corresponds to fusing of observation data and prediction data in data assimilation.

Note that it has newly found out that maximization of the variational lower bound has a face of generalization of minimum variance estimation. That is to say, the high-resolution analytical data y can be estimated by averaging (performing weighted mean on) the observation value o and the prediction data x using their errors as weights. In other words, because an observation value is generally more precise than prediction data, analytical data can be estimated by performing averaging with the weight on an observation value made larger than the weight on prediction data.

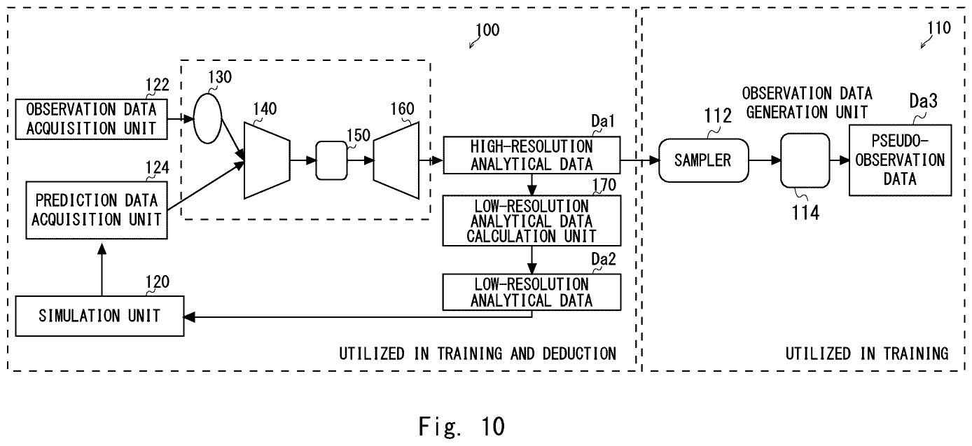

FIG. 10 is a diagram for describing a method for training the constituent elements according to the first embodiment by the variational Bayesian method. In the case of performing training by the variational Bayesian method, the training processing unit 110 has a sampler 112 and an observation data generation unit 114. The sampler 112 and the observation data generation unit 114 may be regarded as a generative model for generating an observation value (pseudo-observation data Da3). A reconstruction error E_{q}[p(o|x, y)] may be calculated by this generative model. Specifically, p(o|x, y) is calculated by the observation data generation unit 114, where p(o|x, y) indicates a distribution of the pseudo-observation data o in a state in which the prediction data x and the high-resolution analytical data y have been set.

On the other hand, the structure transforming unit 130, the latent space-time mapping unit 140, the non-linear transformation unit 150, and the high-resolution analytical data acquisition unit 160 may be regarded as the recognition model as described above. KL divergence may be calculated by this recognition model. Specifically, q(y|x, o) in KL divergence is calculated by the recognition model, where q(y|x,o) indicates a distribution of the high-resolution analytical data y when the prediction data x and the observation data o are received as input. Note that p(y|x) is a prior distribution and is obtained by suitable supposition or by pretraining.

The sampler 112 samples a probability distribution corresponding to the high-resolution analytical data generated by training. The sampler 112 thereby performs replacement from the neural network to a probability distribution (probabilistic model). That is to say, it is difficult for the neural network to perform random output of a probability distribution or the like as it usually performs deterministic output. Thus, the sampler 112 combines a random number sampled from a Gaussian distribution and output (high-resolution analytical data) from the neural network to express a probability distribution in a simulated manner (re-parametrization trick). This enables error estimation of the high-resolution analytical data. Specifically, the probability distribution is expressed in a simulated manner as in Expression (11) below. Note that μ and σ are determinate variables given by the neural network, and ε is a random number sampled from the Gaussian distribution.

[Expression 11]

μ+σ×ϵ (11)

Specifically, the sampler 112 receives the high-resolution analytical data Da1 (corresponding to y in Expression (10)) from the high-resolution analytical data acquisition unit 160. The sampler 112 samples a random number from the Gaussian distribution and adds noise to the high-resolution analytical data. Randomness is thereby added to the high-resolution analytical data given from the neural network. Thus, data that can be regarded as a value sampled from the probability distribution can be acquired. Therefore, the high-resolution analytical data can be expressed as a probability distribution. That is, the sampler 112 acquires sampling data in a case in which the high-resolution analytical data is expressed as the probability distribution. The sampler 112 outputs the sampling data about the high-resolution analytical data to the observation data generation unit 114. Note that in a case of expressing a more complicate probability distribution, that is, in a case of causing noise to be produced from a distribution more complicate than the Gaussian distribution, a mixture distribution, normalizing flows, or the like may be utilized. In this case, a complicate distribution can be obtained by repeating non-linear transformation on a random variable in accordance with a simple probability distribution such as the Gaussian distribution.

The observation data generation unit 114 generates the pseudo-observation data Da3 using the sampling data about the high-resolution analytical data generated by the sampler 112. That is, the observation data generation unit 114 transforms the sampling data about the high-resolution analytical data to the pseudo-observation data Da3. The observation data generation unit 114 may generate the pseudo-observation data Da3 having no loss in the space-time direction. The observation data generation unit 114 may be implemented by a neural network trained in advance by machine learning. The observation data generation unit 114 may be implemented by a neural network in which physical symmetry is reflected. When the pseudo-observation data Da3 is generated, unsupervised learning can be implemented.

Specifically, the observation data generation unit 114 may generate the pseudo-observation data Da3 by performing reversed processing of the processing performed by the structuralizer (the structure transforming unit 130) described above. That is, the observation data generation unit 114 may generate the pseudo-observation data Da3 by a technology substantially similar to the structuralizer. More specifically, the observation data generation unit 114 picks up data on a grid point at an arbitrary time and position from the sampling data about the high-resolution analytical data which is grid data, and repeats linear transformation and non-linear transformation on that data. The observation data generation unit 114 thereby acquires the pseudo-observation data Da3 in a format substantially similar to the format of the observation data o as acquired by the observation data acquisition unit 122. Therefore, the pseudo-observation data Da3 may be non-grid data. In addition, the pseudo-observation data Da3 may indicate a numerical value of a non-physical quantity.

As described above, the training processing unit 110 to which the variational Bayesian method is applied generates the pseudo-observation data Da3 from the high-resolution analytical data Da1. Herein, at the variational lower bound expressed by the fourth expression in Expression (10), the high-resolution analytical data y as deduced is a hidden state. It should be noted that this hidden state is not a final output in a frame of the variational Bayesian method. In the variational Bayesian method, the pseudo-observation data Da3 is a final output in the training stage. Since the high-resolution analytical data y is the hidden state, ground truth data corresponding to the high-resolution analytical data y does not need to be prepared in the training stage. Therefore, it is not necessary to prepare high-accuracy and high-resolution meteorological data which is required in supervised learning.

### (Hardware Configuration Example)

A configuration example of a hardware resource that implements the apparatus and system according to each embodiment described above using a single computing processing apparatus (an information processing apparatus or a computer) will be described. However, the apparatus (information processing apparatus) according to each embodiment may be implemented using at least two computing processing apparatuses physically or functionally. In addition, the apparatus according to each embodiment may be implemented as a dedicated apparatus, or may be implemented as a general-purpose information processing apparatus.

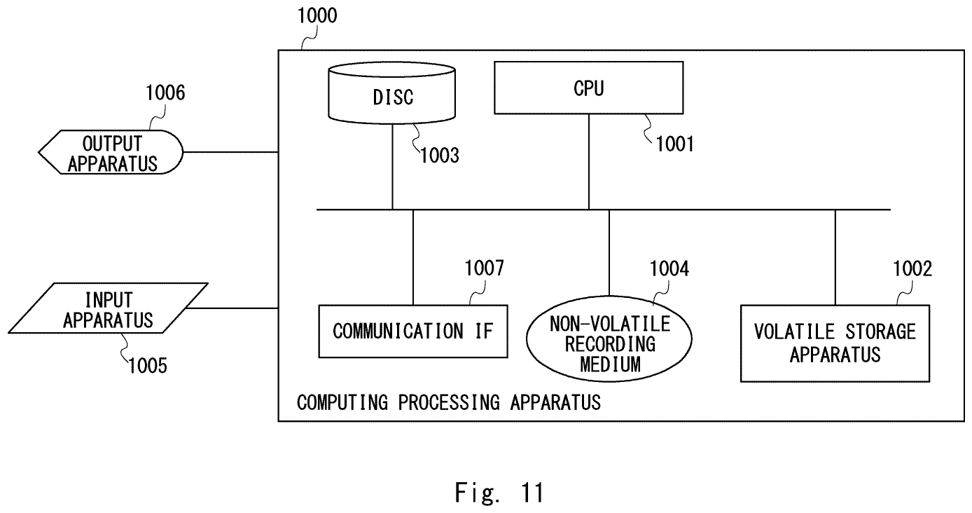

FIG. 11 is a block diagram schematically showing a hardware configuration example of a computing processing apparatus that can implement the apparatus and system according to each embodiment. A computing processing apparatus 1000 has a CPU 1001, a volatile storage apparatus 1002, a disc 1003, a non-volatile recording medium 1004, and a communication interface (IF) 1007. Therefore, the apparatus according to each embodiment can be said to have the CPU 1001, the volatile storage apparatus 1002, the disc 1003, the non-volatile recording medium 1004, and the communication IF 1007. The computing processing apparatus 1000 may be connectable to an input apparatus 1005 and an output apparatus 1006. The computing processing apparatus 1000 may include the input apparatus 1005 and the output apparatus 1006. In addition, the computing processing apparatus 1000 can transmit/receive information to/from another computing processing apparatus and a communication apparatus via the communication IF 1007.

The non-volatile recording medium 1004 is a computer-readable compact disc or digital versatile disc, for example. Alternatively, the non-volatile recording medium 1004 may be a universal serial bus (USB) memory, a solid state drive, or the like. The non-volatile recording medium 1004 holds a related program even without power supplied, enabling portability of the program. Note that the non-volatile recording medium 1004 is not limited to media described above. Alternatively, a related program may be supplied via the communication IF 1007 and a communication network instead of the non-volatile recording medium 1004.

The volatile storage apparatus 1002 is computer readable and can temporarily store data. The volatile storage apparatus 1002 is a memory or the like, such as a dynamic random access memory (DRAM) or a static random access memory (SRAM).

That is to say, the CPU 1001 copies a software program (a computer program: hereinafter simply referred to as a “program”) stored in the disc 1003 to the volatile storage apparatus 1002 when executing the software program, and executes arithmetic processing. The CPU 1001 reads data required for execution of the program from the volatile storage apparatus 1002. The CPU 1001 displays an output result on the output apparatus 1006 in a case in which display is required. In a case in which the program is externally input, the CPU 1001 acquires the program from the input apparatus 1005. The CPU 1001 interprets and executes a program corresponding to the functionalities (processing) of the respective constituent elements shown in FIG. 4, FIG. 6, and FIG. 10 described above. The CPU 1001 executes the processing described in each embodiment described above. In other words, the functionalities of the respective constituent elements shown in FIG. 4, FIG. 6, and FIG. 10 described above may be implemented by the CPU 1001 executing the program stored in the disc 1003 or the volatile storage apparatus 1002.

That is to say, it can be apprehended that each embodiment may be accomplished by the program described above. Moreover, it can be apprehended that each embodiment described above may be accomplished also by a computer-readable non-volatile recording medium having the program described above recorded thereon.

### Modified Examples

Note that the present invention is not limited to the above-described embodiment, and can be changed as appropriate within the scope not departing from the spirit. For example, the order of the respective types of processing (steps) can be changed as appropriate in the flowchart described above. In addition, one or more of a plurality of types of processing (steps) may be omitted. For example, in the flowchart of FIG. 5, the processing in S22 may be executed before the processing in S20. In addition, the processing in S24 may be executed before the processing in S22. In addition, the processing in S70 may be omitted.

In addition, in the embodiment described above, the case of performing meteorological prediction has been described, but the present embodiment is not limited to the case of performing meteorological prediction. The present embodiment can be applied to arbitrary predictive simulation utilizing grid data. For example, the present embodiment can also be applied to oceanographic prediction. The present embodiment can also be applied to astrophysical simulation.

In addition, in the present embodiment, the dimensionality of “space-time” is not limited to four-dimensionality composed of a three-dimensional space and a one-dimensional time. The dimensionality of “space-time” may be three-dimensionality composed of a two-dimensional space and a one-dimensional time. Alternatively, the dimensionality of “space-time” may be dimensionality such as 10-dimensionality larger than four-dimensionality.

In the examples described above, the program includes an instruction group (or software codes) for causing a computer to perform one or more of the functionalities described in the embodiment when read in the computer. The program may be stored in a non-transitory computer-readable medium or a tangible storage medium. As an example and not for limitation, the computer-readable medium or the tangible storage medium includes a random-access memory (RAM), a read-only memory (ROM), a flash memory, a solid state drive (SSD), or another memory technology, a CD-ROM, a digital versatile disk (DVD), a Blu-ray (registered trademark) disk, or another optical disk storage, a magnetic cassette, a magnetic tape, a magnetic disk storage, or another magnetic storage device. The program may be transmitted on a transitory computer-readable medium or a communication medium. As an example and not for limitation, the transitory computer-readable medium or the communication medium includes an electric, optical, acoustic, or another format propagation signal.

This application claims priority based on Japanese Patent Application No. 2022-155991 filed on Sep. 29, 2022, the entire disclosure of which is incorporated herein by reference.

### REFERENCE SIGNS LIST

10 INFORMATION PROCESSING APPARATUS
20 SIMULATION UNIT
22 OBSERVATION DATA ACQUISITION UNIT
24 PREDICTION DATA ACQUISITION UNIT
30 STRUCTURE TRANSFORMING UNIT
40 LATENT SPACE-TIME MAPPING UNIT
50 NON-LINEAR TRANSFORMATION UNIT
60 HIGH-RESOLUTION ANALYTICAL DATA ACQUISITION UNIT
70 LOW-RESOLUTION ANALYTICAL DATA CALCULATION UNIT
100 INFORMATION PROCESSING APPARATUS
110 TRAINING PROCESSING UNIT
112 SAMPLER
114 OBSERVATION DATA GENERATION UNIT
120 SIMULATION UNIT
122 OBSERVATION DATA ACQUISITION UNIT
124 PREDICTION DATA ACQUISITION UNIT
130 STRUCTURE TRANSFORMING UNIT
140 LATENT SPACE-TIME MAPPING UNIT
150 NON-LINEAR TRANSFORMATION UNIT
160 HIGH-RESOLUTION ANALYTICAL DATA ACQUISITION UNIT
170 LOW-RESOLUTION ANALYTICAL DATA CALCULATION UNIT

1. An information processing apparatus comprising:
hardware, including at least one memory configured to store a computer program and at least one processor configured to execute the computer program;
a structure transforming unit, implemented by the hardware, configured to transform a structure of observation data which is data obtained by observing a state in space-time into observation data having a structure of grid data indicating numerical values defined on grid points arranged at a predetermined interval in the space-time;
a latent space-time mapping unit, implemented by the hardware, configured to map the observation data transformed into the grid data and prediction data in a time period at least including a time point of the observation data and a past with respect to the time point, which is grid data in the space-time obtained by simulation, from first real space-time to latent space-time having a smaller number of elements than that in the first real space-time;
a non-linear transformation unit, implemented by the hardware, configured to perform non-linear transformation in the latent space-time on the observation data and the prediction data having been mapped; and
a high-resolution analytical data acquisition unit, implemented by the hardware, configured to map the observation data and the prediction data subjected to the non-linear transformation from the latent space-time to second real space-time having a larger number of elements than that in the latent space-time and having higher resolution than that in the first real space-time, to acquire high-resolution analytical data which is grid data in the space-time and which has higher resolution in the space-time than that in the prediction data, wherein
data assimilation of the observation data and the prediction data is performed by the latent space-time mapping unit and the non-linear transformation unit.

2. The information processing apparatus according to claim 1, further comprising a low-resolution analytical data calculation unit, implemented by the hardware, configured to, using the high-resolution analytical data, calculate low-resolution analytical data having lower resolution in the space-time than that in the high-resolution analytical data.

3. The information processing apparatus according to claim 1, wherein the non-linear transformation unit performs super-resolution in a temporal direction by performing deformation of a data array on the data mapped to the latent space-time.

4. The information processing apparatus according to claim 3, wherein the high-resolution analytical data acquisition unit acquires the high-resolution analytical data by performing super-resolution in a spatial direction on the data on which super-resolution has been performed in the temporal direction in the latent space-time, independently for each time point in the temporal direction.

5. The information processing apparatus according to claim 1, wherein
the prediction data is prediction data in a time period including the time point of the observation data and the past and a future with respect to the time point, and
the high-resolution analytical data acquisition unit acquires high-resolution analytical data in a time period including the past and the future with respect to the time point of the observation data.

6. The information processing apparatus according to claim 1, wherein the structure transforming unit, the latent space-time mapping unit, the non-linear transformation unit, and the high-resolution analytical data acquisition unit are implemented by a trained model trained by a machine learning algorithm.

7. The information processing apparatus according to claim 6, wherein the structure transforming unit, the latent space-time mapping unit, the non-linear transformation unit, and the high-resolution analytical data acquisition unit are implemented by a trained model trained by supervised learning using data having higher resolution in the space-time than that in the prediction data as training data.

8. The information processing apparatus according to claim 6, wherein the structure transforming unit, the latent space-time mapping unit, the non-linear transformation unit, and the high-resolution analytical data acquisition unit are implemented by a trained model trained by unsupervised learning so as to decrease a loss function.

9. An information processing method comprising:
transforming a structure of observation data which is data obtained by observing a state in space-time into observation data having a structure of grid data indicating numerical values defined on grid points arranged at a predetermined interval in the space-time;
mapping the observation data transformed into the grid data and prediction data in a time period at least including a time point of the observation data and a past with respect to the time point, which is grid data in the space-time obtained by simulation, from first real space-time to latent space-time having a smaller number of elements than that in the first real space-time;
performing non-linear transformation in the latent space-time on the observation data and the prediction data having been mapped; and
mapping the observation data and the prediction data subjected to the non-linear transformation from the latent space-time to second real space-time having a larger number of elements than that in the latent space-time and having higher resolution than that in the first real space-time, to acquire high-resolution analytical data which is grid data in the space-time and which has higher resolution in the space-time than that in the prediction data, wherein
data assimilation of the observation data and the prediction data is performed by the mapping from the first real space-time to the latent space-time and the performing the non-linear transformation in the latent space-time on the observation data and the prediction data.

10. A non-transitory computer readable medium storing a program for causing a computer to execute:
processing of transforming a structure of observation data which is data obtained by observing a state in space-time into observation data having a structure of grid data indicating numerical values defined on grid points arranged at a predetermined interval in the space-time;
processing of mapping the observation data transformed into the grid data and prediction data in a time period at least including a time point of the observation data and a past with respect to the time point, which is grid data in the space-time obtained by simulation, from first real space-time to latent space-time having a smaller number of elements than that in the first real space-time;
processing of performing non-linear transformation in the latent space-time on the observation data and the prediction data having been mapped; and
processing of mapping the observation data and the prediction data subjected to the non-linear transformation from the latent space-time to second real space-time having a larger number of elements than that in the latent space-time and having higher resolution than that in the first real space-time, to acquire high-resolution analytical data which is grid data in the space-time and which has higher resolution in the space-time than that in the prediction data, wherein
data assimilation of the observation data and the prediction data is performed by the processing of mapping from the first real space-time to the latent space-time and the processing of performing the non-linear transformation in the latent space-time on the observation data and the prediction data.
